(19) United States
(12) Patent Application Publication
(10) Pub. No.: US 2026/0194772 A1
(43) Pub. Date: Jul. 9, 2026

(54) OPTICAL DEVICES AND METHODS OF MANUFACTURE

(71) Applicant: Taiwan Semiconductor Manufacturing Co., Ltd., Hsinchu (TW)

(72) Inventors: Chun-Yen Peng, Hsinchu (TW); Hau-Yan Lu, Hsinchu (TW); Ying-Kit Felix Tsui, Cupertino, CA (US)

(21) Appl. No.: 19/013,555

(22) Filed: Jan. 8, 2025

(51) Int. Cl. G02F 1/025

(52) U.S. Cl. CPC G02F 1/025; G02F 2201/063; G02F 2201/066; G02F 2202/06

(57) ABSTRACT

A method of forming an optical device as well as the optical device itself are described herein in which a multiple level structure is formed using a method comprising receiving a layer of material over an insulator over a substrate and patterning the layer of material into a first multi-level structure. The first multi-level structure includes a first region, a first plurality of regions on a first side of the first region, each one of the first plurality of regions being at a different level, and a second plurality of regions on a second side of the first region, each one of the second plurality of regions being at a different level. The first multi-level structure is doped to form a first optical modulator.

### BACKGROUND

Electrical signaling and processing is one technique for signal transmission and processing. Optical signaling and processing have been used in increasingly more applications in recent years, particularly due to the use of optical fiber-related applications for signal transmission.

An optical device can provide for the coupling of optical signals from an optical fiber to an optical waveguide for use in optical signaling and processing systems. The efficiency of optical coupling has gradually improved, making the design of tapers relevant to advancing optical signal transmission. However, improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a substrate, in accordance with some embodiments.

FIG. 2 illustrates formation of first openings, in accordance with some embodiments.

FIG. 3 illustrates formation of second openings, in accordance with some embodiments.

FIG. 4 illustrates formation of third openings, in accordance with some embodiments.

FIG. 5 illustrates an isolation step, in accordance with some embodiments.

FIG. 6 illustrates a doping process, in accordance with some embodiments.

FIGS. 7-13 illustrate further process steps to form an optical package, in accordance with some embodiments.

FIGS. 14A-14F illustrate placement and operation of the optical package, in accordance with some embodiments.

FIGS. 15A-15B illustrate varying junction profiles, in accordance with some embodiments.

FIGS. 16A-16B illustrate asymmetric structures, in accordance with some embodiments.

FIGS. 17A-17C illustrate varying doping profiles, in accordance with some embodiments.

FIGS. 18A-18C illustrate curved structures, in accordance with some embodiments.

FIGS. 19A-19C illustrate shaping from multiples directions, in accordance with some embodiments.

FIGS. 20A-20C illustrate differing shapes being shaped from multiples directions, in accordance with some embodiments.

FIG. 21 illustrates multiple modulators, in accordance with some embodiments.

FIG. 22 illustrates a multiple level structure utilized in a photodetector, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be illustrated and discussed with respect to particular embodiments in which a multiple level structure is utilized within optical modulators in order to reduce the resistance through the device without significantly impacting the optical containment of adjacent waveguides. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

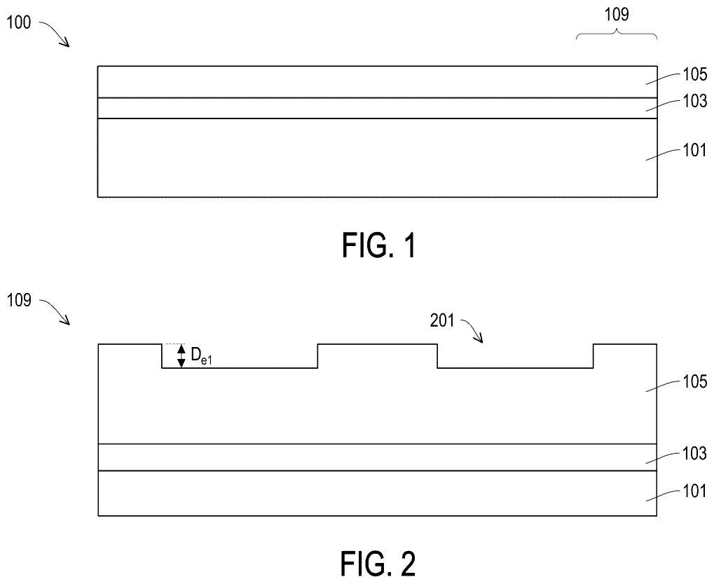

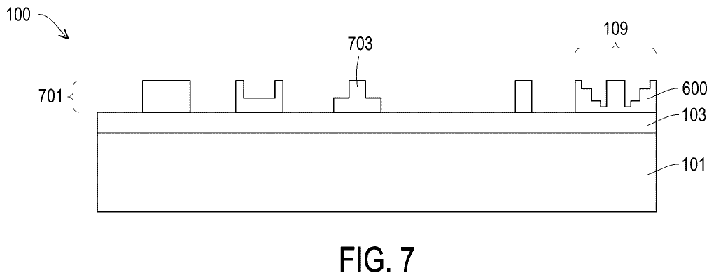

With reference now to FIG. 1, there is illustrated an initial structure of an optical interposer 100. In the particular embodiment illustrated in FIG. 1, the optical interposer 100 is a photonic integrated circuit (PIC) and comprises at this stage a first substrate 101, a first insulator layer 103, and a layer of material 105 for a first active layer 701 of first optical components 703 (not separately illustrated in FIG. 1 but illustrated and discussed further below with respect to FIG. 7). In an embodiment, at a beginning of the manufacturing process of the optical interposer 100, the first substrate 101, the first insulator layer 103, and the layer of material 105 for the first active layer 701 of the first optical components 703 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 701 and can additionally, in some embodiments, serve as a portion of cladding material that surrounds the subsequently manufactured first optical components 703 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 701 is initially (prior to patterning) a conformal layer of material that will be used to begin manufacturing the first active layer 701 of the first optical components 703. In an embodiment, the material 105 for the first active layer 701 may be a translucent material that can be used as a core material for the desired first optical components 703, such as a semiconductor material such as silicon, germanium, silicon germanium, combinations of these, or the like, while in other embodiments the material 105 for the first active layer 701 may be a dielectric material such as silicon nitride or the like, although in other embodiments the material 105 for the first active layer 701 may be III-V materials, lithium niobate materials, or polymers. In embodiments in which the material 105 of the first active layer 701 is deposited, the material 105 for the first active layer 701 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 701 may initially be part of the first substrate 101 prior to the implantation process to form the first insulation layer 103. However, any suitable materials and methods of manufacture may be utilized to form the material 105 of the first active layer 701.

FIG. 1 additionally illustrates a first region 109 in which a first optical modulator 600 (not illustrated in FIG. 1 but illustrated and described further below in FIG. 6), such as a PN phase shift modulator, will be formed. While the first region 109 is illustrated in FIG. 1 as being adjacent to an edge of the device, this is intended to be illustrative and is not intended to be limiting to the embodiments. Rather, the first region 109 may be formed in any desired region of the optical interposer 100.

FIG. 2 illustrates a close up view of the first region 109 as the first optical modulator 600 is formed. As illustrated, the manufacturing of the first optical modulator 600 may be initiated by forming first openings 201 into the layer of material 105. In one particular embodiment the first openings 201 may be formed using one or more photolithographic masking and etching processes, to form the first openings 201 to a first depth Dₑ₁.

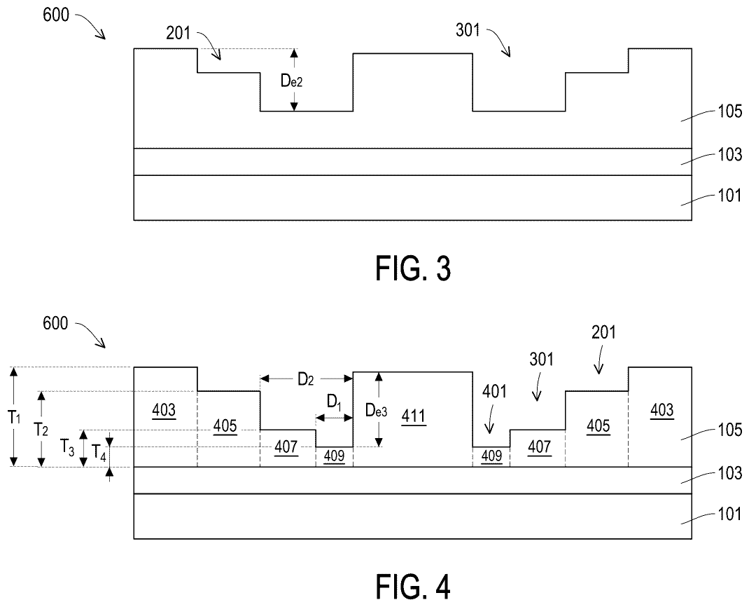

FIG. 3 illustrates the first region 109 after further processing to form the first optical modulator 600. As can be seen, in this step second openings 301 are formed by extending portions of the first openings 201 further into the layer of material 105. In one particular embodiment the second openings 301 may be formed using one or more photolithographic masking and etching processes, to form the second openings 301 to a second depth Dₑ₂ larger than the first depth Dₑ₁.

FIG. 4 illustrates the first region 109 after further processing to form the first optical modulator 600. As can be seen, in this third step third openings 401 are formed by extending portions of the second openings 301 further into the layer of material 105. In one particular embodiment the third openings 401 may be formed using one or more photolithographic masking and etching processes, to form the third openings 401 to a third depth Dₑ₃ larger than the second depth Dₑ₂.

Additionally, by forming the first openings 201, the second openings 301, and the third openings 401 into the layer of material 105, a multiple level connector design is achieved wherein different regions are formed to have top surfaces at different levels or distances from the first substrate 101. In particular, the first optical modulator 600 is formed with a first region 403 with a first thickness T₁, a second region 405 with a second thickness T₂ (less than the first thickness T₁), a third region 407 with a third thickness T₃ (less than the second thickness T₂), and a fourth region 409 with a fourth thickness T₄ (less than the third thickness T₃). Any suitable thicknesses may be utilized.

Also, by forming the first opening 201, the second opening 301, and the third opening 401, a fifth region 411 is formed adjacent to the fourth region 409. The fifth region 411 is formed and manufactured as a waveguide which is connected to other waveguides (not visible in FIG. 4 as the other waveguides extend into and out of the figure). As such, the fifth region 411 receives optical signals that travel through the waveguides and through the first optical modulator 600.

Still looking at the fifth region 411, the third region 407 may be spaced from the fifth region 411 by a first distance D₁ (also the width of the fourth region 409) that is sufficient to prevent undesired coupling between the fifth region 411 and the third region 407. In a particular embodiment the first distance D₁ should be greater than the desired wavelength of the optical signal (λ) divided by (4*n_{eff}), wherein n_{eff} is the transmission mode condition (e.g., single mode or multimode). In particular embodiments the first distance D₁ is greater than about 0.16 μm and less than about 0.36 μm, such as about 0.26 μm. If the first distance D₁ is too low, then there will be undesired optical coupling between the third region 407 and the fifth region 411, while if the first distance D₁ is too large, the overall resistance will be too great.

The second region 405 may be spaced from the fifth region 411 by a second distance D₂ of between about 0.36 μm and about 0.56 μm. If the second distance D₂ is too low, then there will be undesired optical coupling between the third region 407 and the fifth region 411, while if the second distance D₂ is too large, the overall resistance will be too great.

Similarly, the first opening 201, the second opening 301, and the third opening 401 may be mirrored on both sides of the fifth region 411 such that the first region 403, the second region 405, the third region 407, and the fourth region 409 are formed on the opposite side of the fifth region 411 as well. In the embodiment illustrated in FIG. 4 the first region 403, the second region 405, the third region 407, and the fourth region 409 are formed as symmetrical regions on opposite sides of the fifth region 411. However, any suitable asymmetrical structures may be formed.

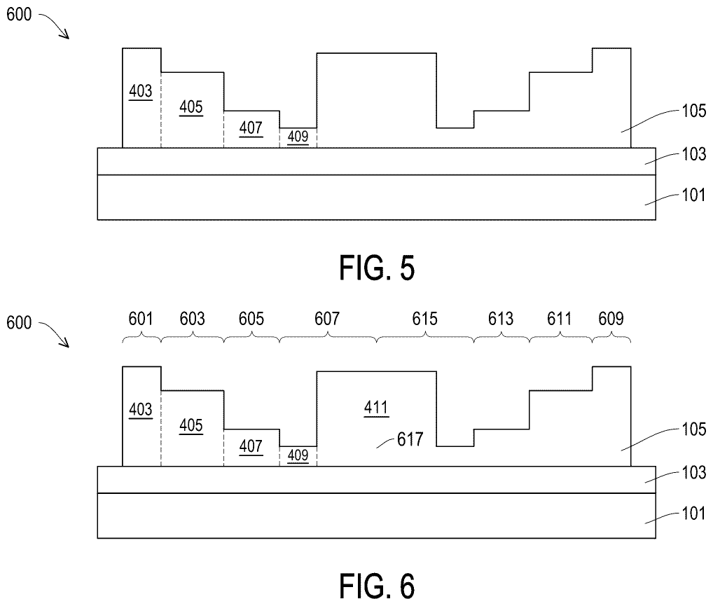

FIG. 5 illustrates an isolation step in order to isolate the first optical modulator 600 from other devices. In an embodiment the isolation step may be performed using one or more photolithographic masking and etching processes. However, any other suitable processes may be utilized.

FIG. 6 illustrates a doping process in order to form the first optical modulator 600 with, e.g., a lateral PN junction (LPN) 617. In an embodiment the doping process may implant dopants to form a lateral gradient doping structure, with a first p-region 601 in the first region 403, a second p-region 603 in the second region 405, a third p-region 605 in the third region 407, and a fourth p-region 607 in the fourth region 409 and the fifth region 411 (as part of a p-n junction).

In an embodiment the first p-region 601, the second p-region 603, the third p-region 605, and the fourth p-region 607 are doped with dopants such as boron, gallium, or the like, using an introduction process such as a photolithographic masking and implantation process or a diffusion process in order to introduce the dopants into the first p-region 601, the second p-region 603, the third p-region 605, and the fourth p-region 607. Once the dopants have been introduced, an anneal may be performed to activate the dopants.

In a particular embodiment the first p-region 601 is a P⁺⁺ region. The second p-region 603 may be a P⁺ region. The third p-region 605 may be a P region. The fourth p-region 607 may be a P region. However, any suitable regions may be utilized.

On the opposite side of the fifth region 411, a series of n-regions are formed. In an embodiment the doping process may implant dopants to form a first n-region 609 in the first region 403, a second n-region 611 in the second region 405, a third n-region 613 in the third region 407, and a fourth n-region 615 in the fourth region 409.

In an embodiment the first n-region 609, the second n-region 611, the third n-region 613, and the fourth n-region 615 may be doped with dopants such as phosphorous, arsenic, or the like, using an introduction process such as a photolithographic masking and implantation process or a diffusion process in order to introduce the dopants into the first n-region 609, the second n-region 611, the third n-region 613, and the fourth n-region 615. Once the dopants have been introduced, an anneal may be performed to activate the dopants.

In a particular embodiment the first n-region 609 is an N⁺⁺ region. The second n-region 611 may be an N⁺ region. The third n-region 613 may be an N region. The fourth n-region 615 may be an N region. However, any suitable regions may be utilized.

FIG. 7 illustrates an expanded view back to the view of FIG. 1 (where the first region 109 is only a portion of the figure) and illustrates further first optical components 703 formed for the first active layer 701 adjacent to the first optical modulator 600. In an embodiment the first optical components 703 for the first active layer 701 are manufactured using the material 105 for the first active layer 701. In embodiments the other first optical components 703 (e.g., not the first optical modulator 600) of the first active layer 701 may include such components as optical waveguides (e.g., ridge waveguides, rib waveguides, buried channel waveguides, diffused waveguides, etc.), directional couplers, other optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 703 may be used.

To begin forming the first active layer 701 of the first optical components 703 from the initial material, the material 105 for the first active layer 701 may be patterned into the desired shapes for the first active layer 701 of first optical components 703. In an embodiment the material 105 for the first active layer 701 may be patterned using, e.g., one or more photolithographic masking and etching processes. However, any suitable method of patterning the material 105 for the first active layer 701 may be utilized. For some of the first optical components 703, the patterning process may be all or at least most of the manufacturing that is used to form these first optical components 703.

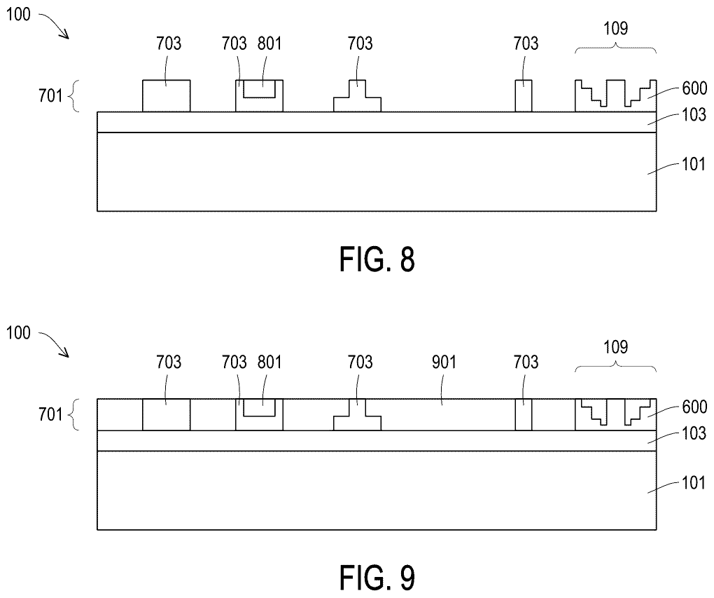

FIG. 8 illustrates that, for those components that utilize further manufacturing processes, such as Mach-Zehnder silicon-photonic switches that utilize resistive heating elements, additional processing may be performed either before or after the patterning of the material for the first active layer 701 for forming the first optical components. For example, implantation processes, additional deposition and patterning processes for different materials (e.g., resistive heating elements, III-V materials for converters), combinations of all of these processes, or the like, can be utilized to help further the manufacturing of the various desired first optical components 703. In a particular embodiment, and as specifically illustrated in FIG. 8, in some embodiments an epitaxial deposition of a semiconductor material 801 such as germanium (used, e.g., for electricity/optics signal modulation and transversion) may be performed on a patterned portion of the material 105 of the first active layer 701. In such an embodiment the semiconductor material 801 may be epitaxially grown in order to help manufacture, e.g., a photodiode for an optical-to-electrical converter. All such manufacturing processes and all suitable first optical components 703 may be manufactured, and all such combinations are fully intended to be included within the scope of the embodiments.

FIG. 9 illustrates that, once the first optical components 703 have been formed, a second insulator layer 901 may be deposited to cover the first optical components 703. The second insulator layer 901 may provide additional cladding material. In an embodiment the second insulator layer 901 may be a dielectric layer that separates the individual components of the first active layer 701 from each other and from the overlying structures and can additionally serve as another portion of cladding material that surrounds the first optical components 703. In an embodiment the second insulator layer 901 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 901 has been deposited, the material may be planarized using, e.g., a chemical mechanical polishing process in order to either planarize a top surface of the second insulator layer 901 (in embodiments in which the second insulator layer 901 is intended to fully cover the first optical components 703) or else planarize the second insulator layer 901 with top surfaces of the first optical components 703. However, any suitable material and method of manufacture may be used.

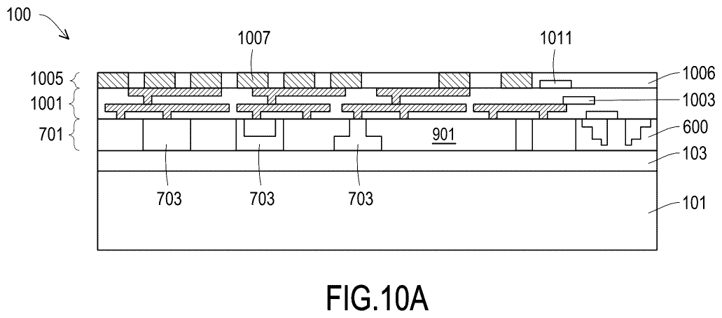

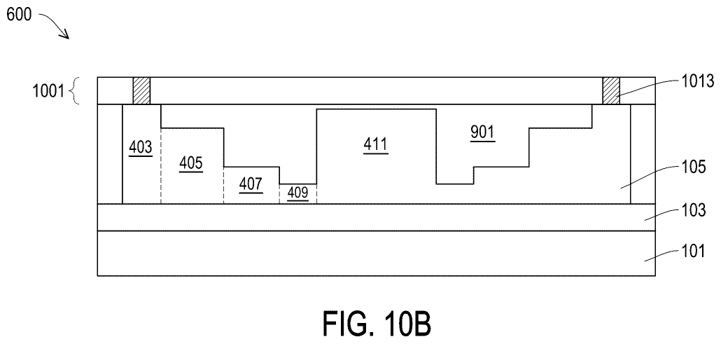

FIG. 10A illustrates that, once the first optical components 703 have been manufactured and the second insulator layer 901 has been formed, one or more second optical components 1003 may be formed as part of first metallization layers 1001. In some embodiments the second optical components 1003 of the first metallization layers 1001 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 1003.

In an embodiment the one or more second optical components 1003 may be formed by initially depositing a material for the one or more second optical components 1003. In an embodiment the material for the one or more second optical components 1003 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 1003 has been deposited or otherwise formed, the material may be patterned into the desired shapes for the one or more second optical components 1003. In an embodiment the material of the one or more second optical components 1003 may be patterned using, e.g., one or more photolithographic masking and etching processes. However, any suitable method of patterning the material for the one or more second optical components 1003 may be utilized.

For some of the one or more second optical components 1003, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 1003. For example, implantation processes, additional deposition and patterning processes for different materials, combinations of all of these processes, or the like, and can be utilized to help further the manufacturing of the various desired one or more second optical components 1003. All such manufacturing processes and all suitable one or more second optical components 1003 may be manufactured, and all such combinations are fully intended to be included within the scope of the embodiments.

In an embodiment the first metallization layers 1001 are formed in order to electrically connect the first active layer 701 of first optical components 703 to control circuitry, to each other, and to subsequently attached devices. In an embodiment the first metallization layers 1001 are formed of alternating layers of dielectric (deposited to cover the one or more second optical components 1003) and conductive material and may be formed through any suitable processes (such as deposition, damascene, dual damascene, etc.). In particular embodiments there may be multiple layers of metallization used to interconnect the various first optical components 703, but the precise number of first metallization layers 1001 is dependent upon the design of the optical interposer 100.

FIG. 10B illustrates a view of the first optical modulator 600 after the first metallization layers 1001 have been formed (wherein only a portion of the first metallization layers 1001 is illustrated in FIG. 10B). As can be seen in FIG. 10B, the first metallization layers 1001 comprise contacts 1013 that make physical and electrical connection to the first regions 403 on opposite sides of the fifth region 411. However, any suitable connections may be utilized.

Returning to FIG. 10A, once the first metallization layers 1001 have been manufactured, a first bonding layer 1005 is formed over the first metallization layers 1001. In an embodiment, the first bonding layer 1005 may be used for a dielectric-to-dielectric and metal-to-metal bond. In accordance with some embodiments, the first bonding layer 1005 is formed of a first dielectric material 1006 such as silicon oxide, silicon nitride, or the like. The first dielectric material 1006 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 1006 has been formed, first openings in the first dielectric material 1006 are formed to expose conductive portions of the underlying layers in preparation to form first bond pads 1007 within the first bonding layer 1005. Once the first openings have been formed within the first dielectric material 1006, the first openings may be filled with a seed layer and a plate metal to form the first bond pads 1007 within the first dielectric material 1006. The seed layer may be blanket deposited over top surfaces of the first dielectric material 1006 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 1006 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 1007 within the first bonding layer 1005. In some embodiments a bond pad via (not separately illustrated) may also be utilized to connect the first bond pads 1007 with underlying conductive portions and, through the underlying conductive portions, connect the first bond pads 1007 with the first metallization layers 1001.

Additionally, the first bonding layer 1005 may also include one or more third optical components 1011 incorporated within the first bonding layer 1005. In such an embodiment, prior to the deposition of the first dielectric material 1006, the one or more third optical components 1011 may be manufactured using similar methods and similar materials as the one or more second optical components 1003 (described above), such as by being waveguides and other structures formed at least in part through a deposition and patterning process. However, any suitable structures, materials and any suitable methods of manufacture may be utilized.

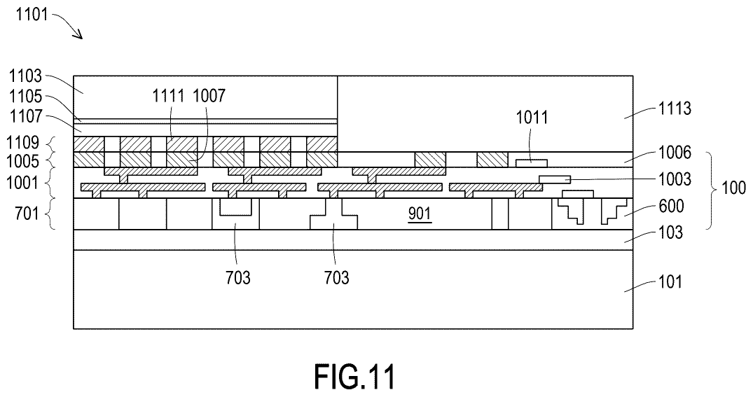

FIG. 11 illustrates a bonding of a first semiconductor device 1101 to the first bonding layer 1005 of the optical interposer 100. In some embodiments, the first semiconductor device 1101 is an electronic integrated circuit (EIC - e.g., a device without optical devices) and may have a semiconductor substrate 1103, a layer of active devices 1105, an overlying interconnect structure 1107, a second bonding layer 1109, and associated third bond pads 1111. In an embodiment the semiconductor substrate 1103 may be similar to the first substrate 101 (e.g., a semiconductor material such as silicon or silicon germanium), the active devices 1105 may be transistors, capacitors, resistors, and the like formed over the semiconductor substrate 1103, the interconnect structure 1107 may be similar to the first metallization layers 1001 (without optical components), the second bonding layer 1109 may be similar to the first bonding layer 1005, and the third bond pads 1111 may be similar to the first bond pads 1007. However, any suitable devices may be utilized.

In an embodiment the first semiconductor device 1101 may be configured to work with the optical interposer 100 for a desired functionality. In some embodiments the first semiconductor device 1101 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 1101 and the first bonding layer 1005 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 1109 and the surfaces of the first bonding layer 1005. Activating the top surfaces of the first bonding layer 1005 and the second bonding layer 1109 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 1005 and the second bonding layer 1109.

After the activation process the optical interposer 100 and the first semiconductor device 1101 may be cleaned using, e.g., a chemical rinse, and then the first semiconductor device 1101 is aligned and placed into physical contact with the optical interposer 100. The optical interposer 100 and the first semiconductor device 1101 are then subjected to thermal treatment and contact pressure to bond the optical interposer 100 and the first semiconductor device 1101. For example, the optical interposer 100 and the first semiconductor device 1101 may be subjected to a pressure of about 200 kPa or less, and a temperature between about 25° C. and about 250° C. to fuse the optical interposer 100 and the first semiconductor device 1101. The optical interposer 100 and the first semiconductor device 1101 may then be subjected to a temperature at or above the eutectic point for material of the first bond pads 1007 and the third bond pads 1111, e.g., between about 150° C. and about 650° C., to fuse the metal. In this manner, the optical interposer 100 and the first semiconductor device 1101 form a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 11 additionally illustrates that, once the first semiconductor device 1101 has been bonded, a first gap-fill material 1113 is deposited in order to fill the space around the first semiconductor device 1101 and provide additional support. In an embodiment the first gap-fill material 1113 may be a material such as silicon oxide, silicon nitride, silicon oxynitride, combinations of these, or the like, deposited to fill and overfill the spaces around the first semiconductor device 1101. However, any suitable material and method of deposition may be utilized.

Once the first gap-fill material 1113 has been deposited, the first gap-fill material 1113 may be planarized in order to expose the first semiconductor device 1101. In an embodiment the planarization process may be a chemical mechanical planarization process, a grinding process, or the like. However, any suitable planarization process may be utilized.

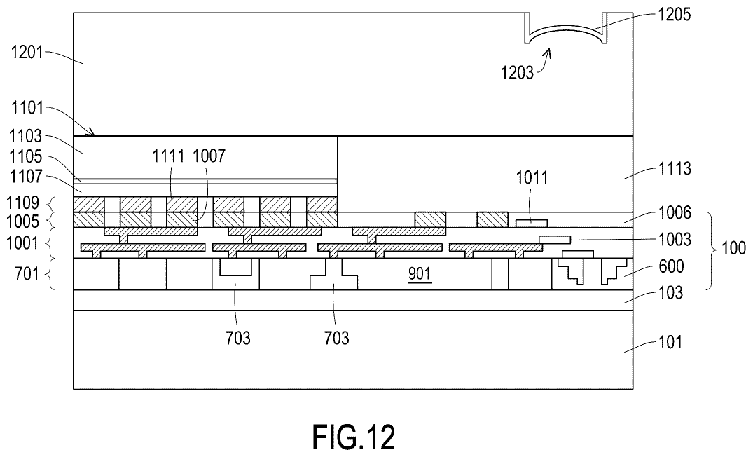

FIG. 12 illustrates an attachment of a first support substrate 1201 to the first semiconductor device 1101 and the first gap-fill material 1113. In an embodiment the first support substrate 1201 may be a support material that is transparent to the wavelength of light that is desired to be used, such as silicon, and may be attached using, e.g., an adhesive (not separately illustrated in FIG. 12). However, in other embodiments the first support substrate 1201 may be bonded to the first semiconductor device 1101 and the first gap-fill material 1113 using, e.g., a bonding process. Any suitable method of attaching the first support substrate 1201 may be used.

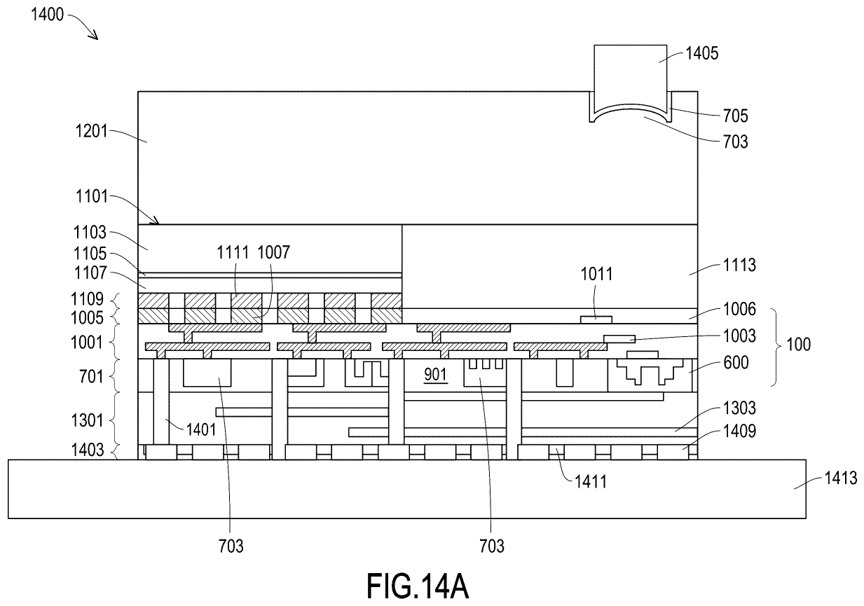

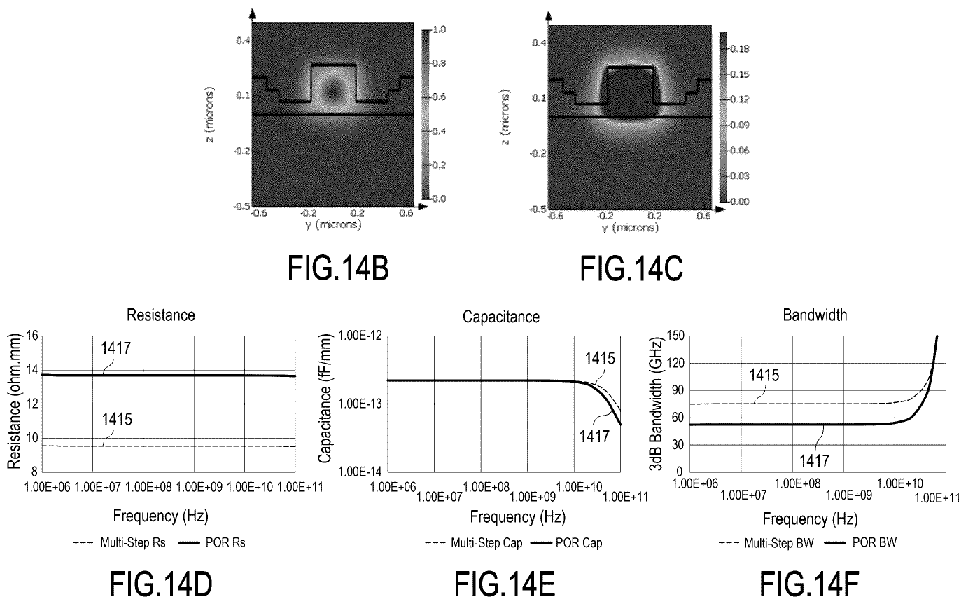

FIG. 12 additionally illustrates that the first support substrate 1201 comprises a first coupling lens 1203 positioned to facilitate movement from an optical fiber 1405 (not illustrated in FIG. 12 but illustrated and described further below with respect to FIG. 14A). In an embodiment the first coupling lens 1203 may be formed by shaping the material of the support substrate (e.g., silicon) using masking and etching processes. However, any suitable process may be utilized.

Additionally, if desired, a first anti-reflective coating (ARC) 1205 may be formed on the first coupling lens 1203. In an embodiment the first ARC 1205 may be one or more layers of materials which help to prevent undesired reflections as light is focused through the first coupling lens 1203. In a particular embodiment the one or more layers of materials may be materials such as silicon oxide, silicon nitride, combinations of these, or the like, formed using processes such as chemical vapor deposition, atomic layer deposition, physical vapor deposition, oxidation, nitridation, combinations of these, or the like.

In a particular embodiment the first ARC 1205 may be formed using a first layer of silicon oxide and a first layer of silicon nitride formed over the first layer of silicon oxide. A second layer of silicon oxide and a second layer of silicon nitride are deposited over the first layer of silicon oxide and the first layer of silicon nitride, forming an alternating stack of silicon oxide and silicon nitride. Once all of the desired layers have been deposited, the layers may be patterned using, e.g., a photolithographic masking and etching process. However, any suitable combinations of materials and processes may be utilized.

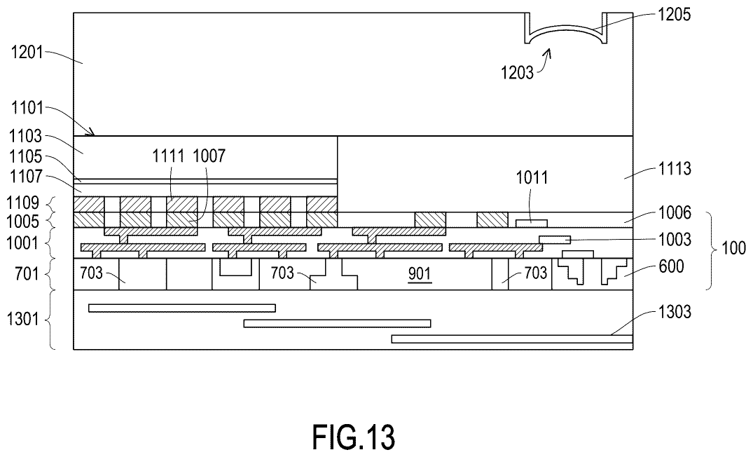

FIG. 13 illustrates a removal of the first substrate 101 and, optionally, the first insulator layer 103, thereby exposing the first active layer 701 of first optical components 703. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 1301 of fourth optical components 1303 may be formed on a back side of the first active layer 701. In an embodiment the second active layer 1301 of fourth optical components 1303 may be formed using similar materials and similar processes as the second optical components 1003 of the first metallization layers 1001 (described above with respect to FIG. 10A). For example, the second active layer 1301 of fourth optical components 1303 may be formed of alternating layers of a cladding material such as silicon oxide and core material such as silicon nitride formed using deposition and patterning processes in order to form optical components such as waveguides and the like.

FIG. 14A illustrates formation of first through device vias (TDVs) 1401 and formation of a third bonding layer 1403 to form a first optical package 1400 which, in some embodiments, is a compact universal photonic engine (COUPE). In an embodiment the first through device vias 1401 extend through the second active layer 1301 and the first active layer 701 so as to provide a quick passage of power, data, and ground through the optical interposer 100. In an embodiment the first through device vias 1401 may be formed by initially forming through device via openings into the optical interposer 100. The through device via openings may be formed by applying and developing a suitable photoresist (not shown), and removing portions of the second active layer 1301 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 1401 have been formed, second metallization layers (not separately illustrated in FIG. 14A) may be formed in electrical connection with the first through device vias 1401. In an embodiment the second metallization layers may be formed as described above with respect to the first metallization layers 1001, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 1403 is formed in order to provide electrical connections between the optical interposer 100 and subsequently attached devices. In an embodiment the third bonding layer 1403 may be similar to the first bonding layer 1005, such as having third bond pads 1409 (similar to the first bond pads 1007) and even fifth optical components 1411 (similar to the third optical components 1011). However, any suitable devices may be utilized.

Optionally, although not shown in FIG. 14A, first external connectors may be formed to provide conductive regions for contact between the third bond pads 1409 to other external devices, such as an interposer substrate 1413 or printed circuit board. The first external connectors may be conductive bumps (e.g., C4 bumps, ball grid arrays, microbumps, etc.) or conductive pillars utilizing materials such as solder and copper. In an embodiment in which the first external connectors are contact bumps, the first external connectors may comprise a material such as tin, or other suitable materials, such as silver, lead-free tin, or copper. In an embodiment in which the first external connectors are tin solder bumps, the first external connectors may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Of course, while the use of first external connectors is one embodiment which may be used in order to provide connections for the first optical package 1400, this is intended to be illustrative and is not intended to limit the embodiments. Rather, any suitable method of physically, electrically, and in some cases optically connecting the first optical package 1400, such as dielectric-to-dielectric and metal-to-metal bonding, may also be utilized. Any suitable method of bonding the first optical package 1400 may be used.

FIG. 14A also illustrates placement of an optical fiber 1405. In an embodiment the optical fiber 1405 may be placed such that optical signals may be transmitted between the optical fiber 1405 and, e.g., the first optical components 703. In an embodiment the optical fiber 1405 may be aligned using, e.g., a fiber array unit (FAU - not separately illustrated) and may be attached using, e.g., an optical glue.

By forming the first optical modulator 600 using a multiple-level connection structure, an ultra-low resistance design may be obtained. In particular, the larger sections (e.g., the first region 403, the second region 405, and the third region 407) may be used to reduce the parasitic resistance (by having a larger thickness in these regions), while the smaller sections (e.g., the fourth region 409) have a reduced thickness in order to maintain the confinement of the optical signals passing through the waveguide within the fifth region 411. In the embodiments presented, the power overlap ratio within the waveguide within the fifth region 411 may be greater than 90%, wherein the power overlap ratio is determined by the power integral within the fifth region 411 divided by the total transmission mode power. As such, this ultra-low resistance design can be obtained while minimizing losses of the optical signal to unwanted coupling between the fifth region 411 and adjacent materials.

FIGS. 14B-14C illustrate a cross-sectional view of the first optical modulator 600 during a simulated operation, when an optical signal it transiting through the waveguide within the fifth region 411. As can be seen, for embodiments in which the first distance D₁ is 0.26 μm and the second distance D₂ is 0.36 μm, the optical signal is 90% within the waveguide and there is very little loss of the optical signal due to optical coupling.

FIGS. 14D-14F illustrate simulation scenarios which illustrate some of the benefits that can be obtained using the multi-level structure, with FIG. 14D illustrating a resistance/frequency chart, FIG. 14E illustrating a capacitance/frequency chart, and FIG. 14F illustrating a bandwidth/frequency chart. In these figures, the line labeled 1415 illustrates results using the multi-level structure described above, while the line labeled 1417 illustrates results using a previous device without the multiple level structure. As can be seen, by using the multi-level structure, the capacitance can be kept consistent, the resistance can be reduced by 30%, and the bandwidth can be increased by 43%.

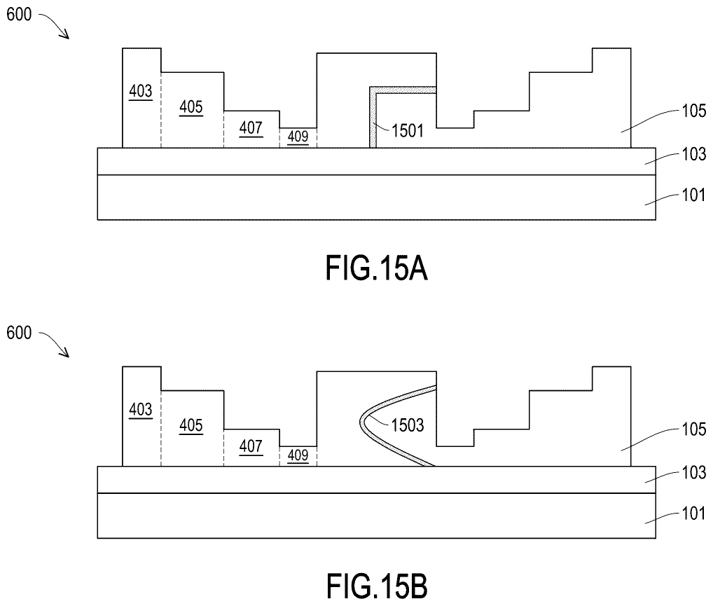

FIGS. 15A-15B illustrate additional embodiments which utilize different junction profiles within the first optical modulator 600. As illustrates in FIG. 15A, in some embodiments the first optical modulator 600 may have a vertical PN junction (VPN) 1501 within the fifth region 411, while FIG. 15B illustrates embodiments in which a C-shaped profile 1503 is utilized. All such profiles are fully intended to be included within the scope of the embodiments.

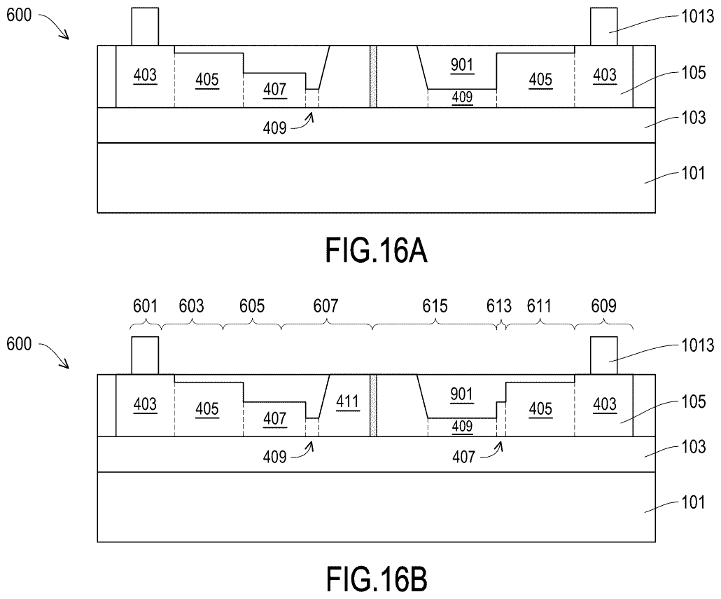

FIGS. 16A-16B illustrate other embodiments which utilize asymmetric structures in order to help tune the resistance and optical losses. In the embodiment illustrated in FIG. 16A, the first region 403, the second region 405, the third region 407 and the fourth region 409 are formed on one side of the waveguide as described above with respect to FIG. 4. On the other side, however, instead of there being a symmetrical structure, there is an asymmetrical structure where there is a difference in the number of regions. For example, in the illustrated embodiment the first region 403, the second region 405, and the fourth region 409 are manufactured, but the third region 407 is not manufactured.

FIG. 16B illustrates a similar embodiment as the structure in FIG. 16A, but in which the third region 407 remains. In this embodiment, however, the overall width of the third region 407 and the fourth region 409 are not the same on both sides of the fifth region 411. For example, the third region 407 on the right side has a smaller width than the third region 407 on the left side of the fifth region 411, while the fourth region 409 on the right side has a larger width than the fourth region 409 on the left side of the fifth region 411.

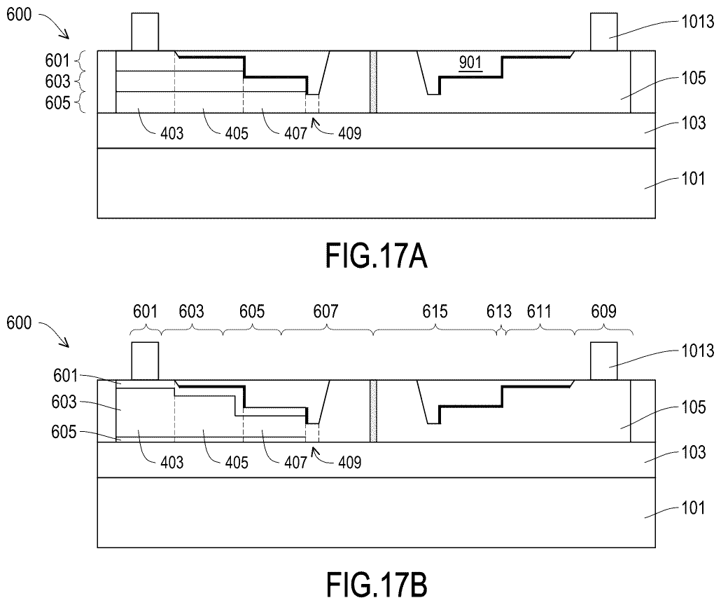

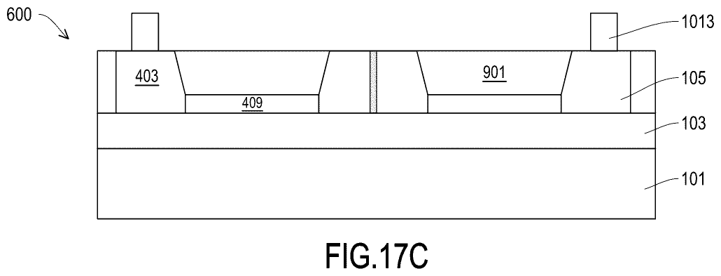

FIGS. 17A-17B illustrate further embodiments in which alternative gradient dopings are utilized (instead of the lateral gradient doping illustrated above with respect to FIG. 6). In the embodiment illustrated in FIG. 17A, instead of the lateral doping gradient, a vertical gradient doping is utilized (illustrated on one side of the structure but not the other side for clarity). For example, in this embodiment the first p-region 601 (which extends through both the first region 403 and the second region 405) is located above the second p-region 603 (which extends through the first region 403, the second region 405, and the third region 407), which is located over the third p-region 605 (which extends through the first region 403, the second region 405, and the third region 407). In an embodiment the different regions may be formed using multiple masking and implantation processes. However, any suitable methods may be utilized.

In the embodiment illustrated in FIG. 17B, a surface heavy doping profile is utilized (illustrated on one side of the structure but not the other side for clarity). In this embodiment, the first p-region 601 is located above the second p-region 603, which is located over the third p-region 605, with each region extending through each of the first region 403, the second region 405, and the third region 407. In this embodiment the first p-region 601 is formed to have a similar shape as the surface of the material 105, and the different regions may be formed multiple implantations processes with different powers being used in order to implant to different depths. However, any suitable method may be utilized.

FIG. 17C illustrates one more embodiment in which gradient doping profile may be utilized. In this embodiment the gradient doping profile is utilized when there are only two regions, such as the first region 403 and the fourth region 409. However, any suitable number of regions may be utilized.

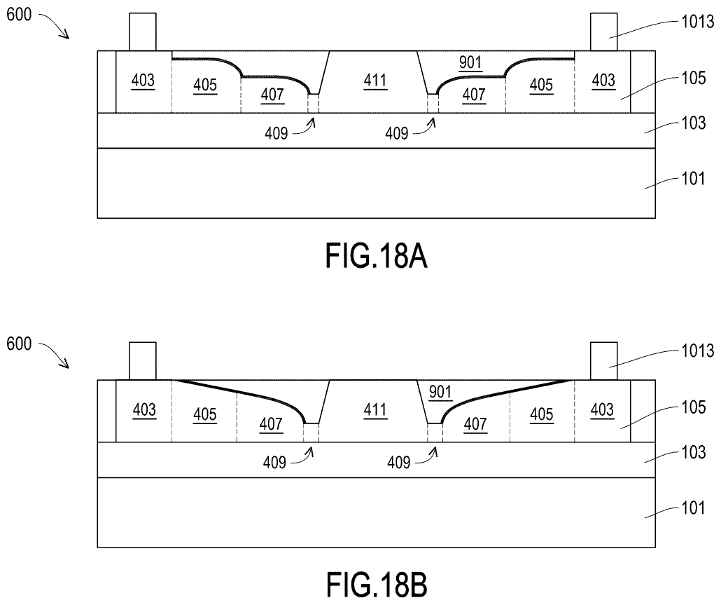

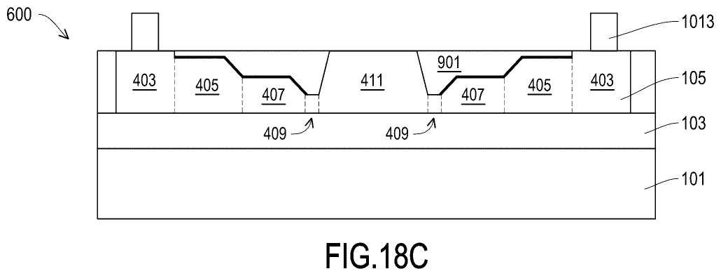

FIGS. 18A-18C illustrate further structures that may be used in order to obtain the desired shape for the multiple level connection structures. For example, in FIG. 18A the second region 405 and the third region 407 are formed with curved surfaces in order to form a wavy connection structure, while in FIG. 18B the second region 405 and the third region 407 are formed in a parabola connection structure. Finally, in FIG. 18C the second region 405 and the third region 407 are formed with a trapezoidal connection structure. However, any suitable shape may be utilized.

In order to obtain the desired structures in FIG. 18A-18C, different etching processes from those described above may be used. For example, the curvature of the structures may be changed through the use of a grayscale mask or etching angle controls. However, any suitable process or combination of processes may be utilized.

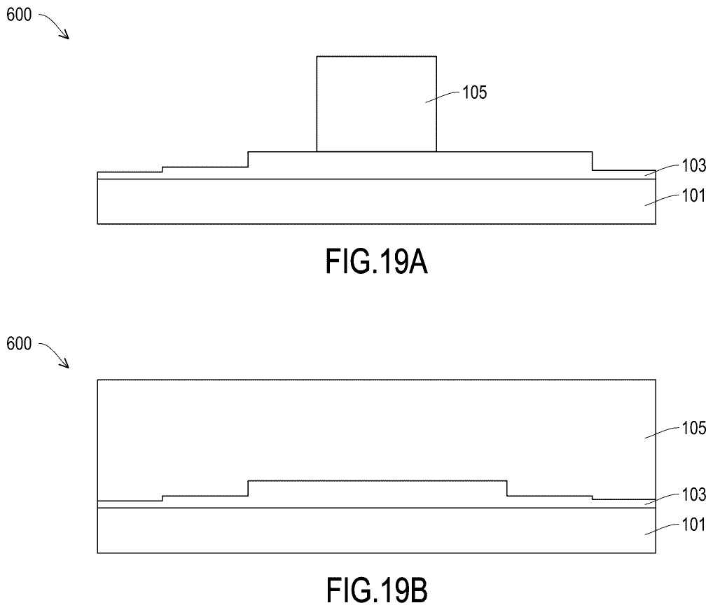

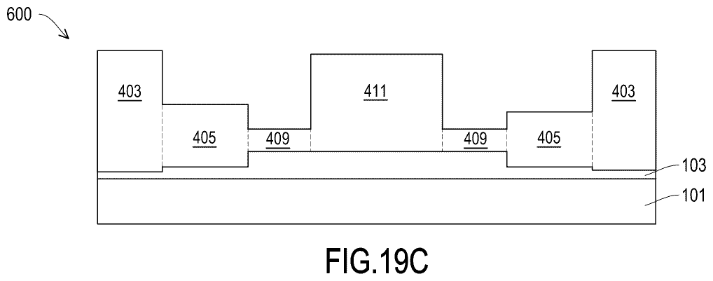

FIGS. 19A-19C illustrate yet another embodiment in which the first region 403, the second region 405, and the fourth region 409 (without the third region 407 in this embodiment) are shaped not only from the top (as described above with respect to FIGS. 2-6) but are also shaped from below. In these embodiments, and looking first at FIG. 19A, after receiving the first substrate 101, the first insulator layer 103, and the layer of material 105, the layer of material 105 and the first insulator layer 103 may be shaped to form a second multiple level structure using a series of photolithographic masking and etching processes. In a particular embodiment, the shape of the first insulator layer 103 after the patterning may be complementary to the shape of the first region 403, the second region 405, and the fourth region 409 (see, e.g., FIG. 5). However, any suitable shape may be utilized.

FIG. 19B illustrates that, once the first insulator layer 103 has been patterned into the desired shape (e.g. the second multiple level structure), the layer of material 105 may be regrown. In an embodiment the layer of material 105 may be regrown using an epitaxial growth process, such that the surface of the layer of material 105 facing the first substrate 101 takes on the shape of the patterned underlying layer of the first insulator layer 103. However, any suitable growth process may be utilized.

Additionally, once the layer of material 105 has been regrown, the layer of material 105 may be planarized in order to provide a planar surface for further processing. In an embodiment the regrown layer of material 105 may be planarized using, e.g., a planarization process such as a chemical mechanical polishing process. However, any suitable planarization process, such as grinding or even a series of one or more etches, may be utilized.

FIG. 19C illustrates that, once the layer of material 105 has been regrown and planarized, the layer of material 105 may be patterned in order to form the multi-level structure as described above with respect to FIG. 4. In an embodiment the layer of material 105 may be patterned into the first region 403, the second region 405, and the fourth region 409 using a series of photolithographic masking and etching processes. However, any suitable method of patterning the layer of material 105 may be utilized.

Additionally, while not explicitly illustrated, once the layer of material 105 has been patterned, the additional processing that has been discussed may also be performed. For example, the layer of material 105 may be doped as described (using, e.g., a gradient doping process or other desired doping processes) and additional structures may be formed. Any suitable processes may be used, and all such processes are fully intended to be included within the scope of the embodiments.

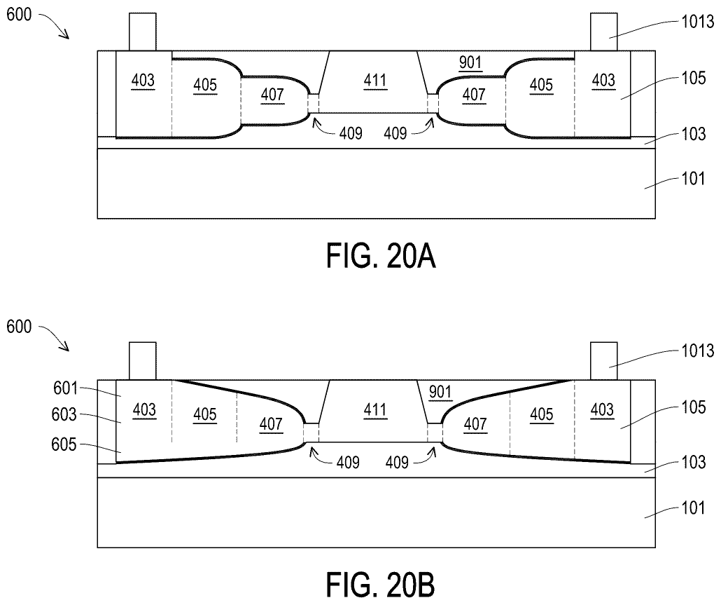

FIGS. 20A-20C illustrate further structures that may be used in order to obtain the desired shape for the multiple level connection structures. For example, in FIG. 20A the first region 403, the second region 405, the third region 407, and the fourth region 409 are formed with curved surfaces on both sides in order to a wavy connection structure, while in FIG. 20B the first region 403, the second region 405, the third region 407, and the fourth region 409 are formed in more of a parabola connection structure. However, any suitable shape may be utilized.

Finally, in FIG. 20C the first region 403, the second region 405, the third region 407, and the fourth region 409 are formed with a trapezoidal connection structure. FIG. 20C additionally specifically illustrates that the shapes of the first region 402, the second region 405, the third region 407 and the fourth region 409, may have symmetrical shapes on the top surface and the bottom surface, in other embodiments the shapes may be asymmetrical. Any suitable shape may be utilized.

In order to obtain the desired shapes for the first region 403, the second region 405, the third region 407, and the fourth region 409 in FIGS. 20A-20C, different etching processes from those described above may be used. For example, the curvature of the first region 403, the second region 405, the third region 407, and the fourth region 409 may be changed through the use of a grayscale mask or etching angle controls. However, any suitable process or combination of processes may be utilized.

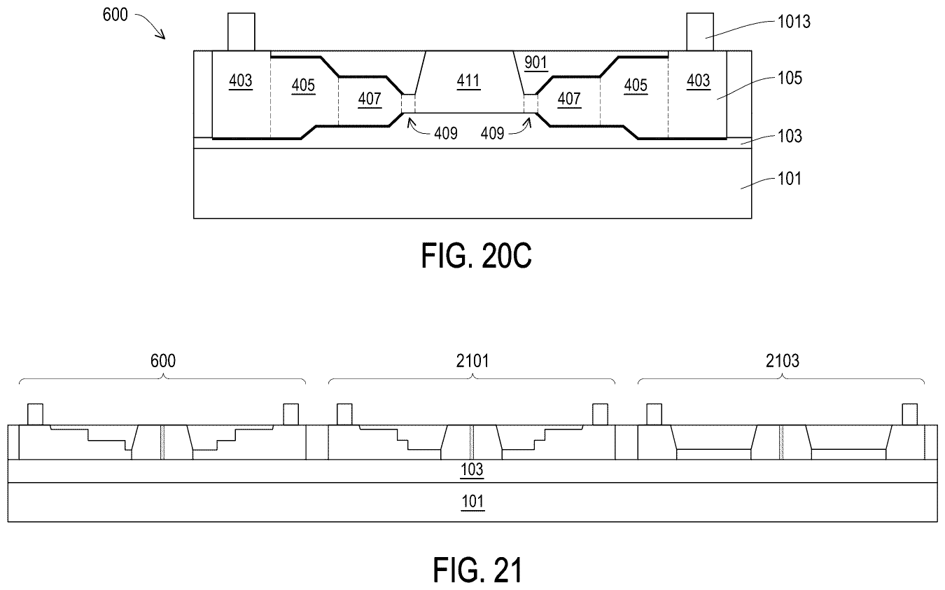

FIG. 21 illustrates another embodiment in which multiple modulators, including the first optical modulator 600, a second optical modulator 2101, and a third optical modulator 2103 are formed in a parallel design with each other. In an embodiment each of the optical modulators may be formed using a different one of the embodiments described above with respect to FIGS. 1-20C. For example, the first optical modulator 600 may be formed with asymmetric structures as described above with respect to FIG. 16B, the second optical modulator 2101 may be formed with a symmetrical structure as described above with respect to FIG. 16B, and the third optical modulator 2103 may be formed symmetrically with a modulated dopant concentration as described above with respect to FIG. 17C. Using differently designed modulators in parallel with each other allows for an overall modulator that can better handle multiple wavelengths and allows for adjustment of the overall impedance. However, any suitable combination of devices may be utilized, and all such combinations are fully intended to be included within the scope of the embodiments.

Additionally, while the embodiments described above utilized the multiple level structure in an optical modulator with a specific structure, this is intended to be illustrative and is not intended to be limiting to the embodiments. Rather, the ideas presented may be incorporated into a wide variety of optical modulators, such as a micro-ring modulator (MRM), a Mach-Zehnder modulator (MZM), a phase shifter PS modulator, a photodetector, combinations of these, or the like.

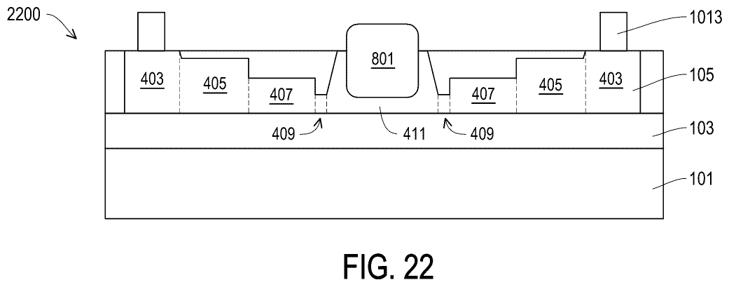

For example, FIG. 22 illustrates one such embodiment in which the multiple level structure is utilized in a photodetector 2200. In this embodiment the multiple-level structure is utilized in a photodetector with the semiconductor material 801 (described above with respect to FIG. 8) in order to provide for electricity/optics signal modulation and transversion. The multiple level structure maybe incorporated into a wide variety of devices, and all such devices are fully intended to be included within the scope of the embodiments.

By incorporating the multiple-level structures into optical modulators such as the first optical modulator 600, an ultra-low resistance design may be obtained. In particular, the larger/thicker sections (e.g., the first region 403, the second region 405, and the third region 407) may be used to reduce the parasitic resistance (by having a larger thickness in these regions), while the smaller sections (e.g., the fourth region 409) have a reduced thickness in order to maintain the confinement of the optical signals passing through the waveguide within the fifth region 411. In the embodiments presented, the power overlap ratio within the waveguide within the fifth region 411 may be greater than 90%, wherein the power overlap ratio is determined by the power integral within the fifth region 411 divided by the total transmission mode power. As such, this ultra-low resistance design can be obtained while minimizing losses of the optical signal to unwanted coupling between the fifth region 411 and adjacent materials.

In some embodiments, a method of forming an optical device, the method including: receiving a layer of material over an insulator over a substrate; patterning the layer of material into a first multi-level structure, the first multi-level structure including: a first region; a first plurality of regions on a first side of the first region, each one of the first plurality of regions being at a different level; and a second plurality of regions on a second side of the first region, each one of the second plurality of regions being at a different level; doping the first multi-level structure to form a first optical modulator. In an embodiment the first plurality of regions is symmetrical to the second plurality of regions around the first region. In an embodiment the first plurality of regions is asymmetrical to the second plurality of regions around the first region. In an embodiment widths of the first plurality of regions is asymmetrical to widths of the second plurality of regions. In an embodiment a number of the first plurality of regions is asymmetrical to a number of the second plurality of regions. In an embodiment the method further includes patterning the insulator into a second multiple level structure. In an embodiment the implanting the dopants forms a gradient concentration of the dopants.

In another embodiment, a method of forming an optical device, the method including: forming a first opening into a layer of material, the layer of material being located over a first insulator layer and a substrate; extending a portion of the first opening deeper into the layer of material to form a second opening, wherein the forming the first opening and the extending forms a multi-level structure; and after the extending, implanting dopants into the layer of material to form a first optical modulator. In an embodiment the implanting the dopants forms a lateral gradient. In an embodiment the implanting the dopants forms a vertical gradient. In an embodiment the implanting the dopants forms a surface heavy dopant concentration. In an embodiment the method further includes: prior to the forming the first opening, patterning the layer of material and the first insulator layer to form a second multi-level structure from the layer of material; and prior to the forming the first opening, regrowing the layer of material. In an embodiment the forming the first opening and the extending forms a wavy structure. In an embodiment the forming the first opening and the extending forms a parabola structure.

In yet another embodiment, an optical device includes: a first insulator layer over a substrate; a first multilayer structure extending away from a first region; a second multilayer structure extending away from the first region, wherein the first multilayer structure and the second multilayer structure form a first optical modulator; a first contact in physical contact with the first multilayer structure; and a second contact in physical contact with the second multilayer structure. In an embodiment the first multilayer structure is symmetrical with the second multilayer structure. In an embodiment the first multilayer structure is asymmetrical with the second multilayer structure. In an embodiment the first multilayer structure comprises a first plurality of regions, wherein the second multilayer structure comprises a second plurality of regions and wherein widths of the first plurality of regions is asymmetrical to widths of the second plurality of regions. In an embodiment the first multilayer structure comprises a first plurality of regions, wherein the second multilayer structure comprises a second plurality of regions and wherein a number of the first plurality of region is asymmetrical to a number of the second plurality of regions. In an embodiment the first multilayer structure has a trapezoidal shape.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of forming an optical device, the method comprising:
receiving a layer of material over an insulator over a substrate;
patterning the layer of material into a first multi-level structure, the first multi-level structure comprising:
a first region;
a first plurality of regions on a first side of the first region, each one of the first plurality of regions being at a different level; and
a second plurality of regions on a second side of the first region, each one of the second plurality of regions being at a different level;
doping the first multi-level structure to form a first optical modulator.

2. The method of claim 1, wherein the first plurality of regions is symmetrical to the second plurality of regions around the first region.

3. The method of claim 1, wherein the first plurality of regions is asymmetrical to the second plurality of regions around the first region.

4. The method of claim 3, wherein widths of the first plurality of regions is asymmetrical to widths of the second plurality of regions.

5. The method of claim 3, wherein a number of the first plurality of regions is asymmetrical to a number of the second plurality of regions.

6. The method of claim 1, further comprising patterning the insulator into a second multiple level structure.

7. The method of claim 1, wherein the implanting the dopants forms a gradient concentration of the dopants.

8. A method of forming an optical device, the method comprising:
forming a first opening into a layer of material, the layer of material being located over a first insulator layer and a substrate;
extending a portion of the first opening deeper into the layer of material to form a second opening, wherein the forming the first opening and the extending forms a multi-level structure; and
after the extending, implanting dopants into the layer of material to form a first optical modulator.

9. The method of claim 8, wherein the implanting the dopants forms a lateral gradient.

10. The method of claim 8, wherein the implanting the dopants forms a vertical gradient.

11. The method of claim 8, wherein the implanting the dopants forms a surface heavy dopant concentration.

12. The method of claim 8, further comprising:
prior to the forming the first opening, patterning the layer of material and the first insulator layer to form a second multi-level structure from the layer of material; and
prior to the forming the first opening, regrowing the layer of material.

13. The method of claim 8, wherein the forming the first opening and the extending forms a wavy structure.

14. The method of claim 8, wherein the forming the first opening and the extending forms a parabola structure.

15. An optical device comprising:
a first insulator layer over a substrate;
a first multilayer structure extending away from a first region;
a second multilayer structure extending away from the first region, wherein the first multilayer structure and the second multilayer structure form a first optical modulator;
a first contact in physical contact with the first multilayer structure; and
a second contact in physical contact with the second multilayer structure.

16. The optical device of claim 15, wherein the first multilayer structure is symmetrical with the second multilayer structure.

17. The optical device of claim 15, wherein the first multilayer structure is asymmetrical with the second multilayer structure.

18. The optical device of claim 17, wherein the first multilayer structure comprises a first plurality of regions, wherein the second multilayer structure comprises a second plurality of regions and wherein widths of the first plurality of regions is asymmetrical to widths of the second plurality of regions.

19. The optical device of claim 15, wherein the first multilayer structure comprises a first plurality of regions, wherein the second multilayer structure comprises a second plurality of regions and wherein a number of the first plurality of region is asymmetrical to a number of the second plurality of regions.

20. The optical device of claim 15, wherein the first multilayer structure has a trapezoidal shape.
